(19) United States
(12) Patent Application Publication
(10) Pub. No.: US 2018/0237010 A1
(43) Pub. Date: Aug. 23, 2018

(54) Motor Vehicle Maximum speed setter limiter

(71) Applicant: Christopher Choi, Glenwood, MD (US)

(72) Inventor: Christopher Choi, Glenwood, MD (US)

(21) Appl. No.: 15/439,900

(22) Filed: Feb. 22, 2017

(51) Int. Cl. B60W 30/14; B60W 50/08

(52) U.S. Cl. CPC B60W 30/146; B60W 50/085; B60W 2550/402; B60W 2720/10; B60W 2550/22

(57) ABSTRACT

Control system and method for controlling a vehicle or a component of a vehicle in which a maximum speed limit of a vehicle is activated by the driver and set by a GPS or a type of posted speed limit database. A user controlled means such as a button, knob, switch, touch pad, or voice allows driver to set the maximum allowable speed of the vehicle based on the roads posted speed limit, or manual input of the driver's choice. Once the speed limiter invention is engaged, the vehicle will not go past the posted speed limit regardless how much the accelerator pedal is depressed.

### CROSS-REFERENCES TO RELATED APPLICATIONS

Not applicable.

### STATEMENT REGARDING FEDERALLY SPONSORED RESEARCH OR DEVELOPMENT

Not applicable.

### REFERENCES TO MICROFICHE APPENDIX

Not applicable.

### BACKGROUND

Field of Invention

This invention relates to ensuring the driver of a motor vehicle will not exceed a posted speed limit of the road being traveled on. The speed limiter is engaged by a switch, knob, button, touch pad, or voice activation to engage the system. The speed data of a given road is extracted from a GPS, GPS like device, or speed limit database, and the control system will extract the maximum speed limit information. With the speed limit defined, the vehicle can now be set to ensure the vehicle is limited to the posted speed limit regardless of how much the accelerator pedal is depressed. The speed limit controller can be shut off by a button, switch, voice, touchpad, or voice de-activation.

### Discussion of Prior Art

Many other inventions that attempt to use parameter from a GPS, or some type of speed setting function either:

Are similar to a cruise control system. This system is a type of speed limiter but it is designed to maintain constant vehicle speed once it is engaged. The said invention allows the driver to vary vehicle speed range from reverse to zero mph to the road's posted speed limit.

Are specifically geared toward safety stabilization type of system. This system also reads roads posted speed limit but it is being used by the vehicle system for accident avoidance purpose. The said invention does not interfere or manipulate any of the vehicle's handling characteristics.

Are using GPS data to provide map guidance and current moving vehicle's speed. The system also receives the road's posted speed limit but it is for pure visual purpose only. It is not connected to vehicle acceleration and deceleration system.

There are inventions such as described in U.S. Pat. No. 5,504,482, issued to Schredder on Apr. 2, 1996 that use similar input to the vehicle control system, but it is more of a traffic avoidance routing mapper rather than a maximum speed limit controller.

Another control system such as U.S. Pat. No. 6,768,944 B2, issued to Breed on Jul. 27, 2004 uses inertial reference unit and GPS for accident avoidance purpose.

A vehicle control system as described in Pub. No. 2003/0182026 A1 issued to Awada on Sep. 25, 2003 uses various sensor inputs, driver input, and GPS input to control various Automobile Control Systems nodes and customize warnings and alerts to the driver.

The U.S. Pat. No. 6,657,584 B2, issued to Cavallaro on Dec. 2, 2003 uses GPS input for determining position and location rather than using it to limit vehicle maximum speed.

The U.S. Pat. No. 5,948,043, issued to Mathis on Sep. 7, 1999 is an invention that pertains to improving vehicle navigation using the GPS.

There are other inventions for innovating cruise control system. Included have been U.S. Pat. No. 6,037,862, issued to Ying on Mar. 14, 2000; The U.S. Pat. No. 5,230,400, issued to Kakinami on Jul. 27, 1993;

The U.S. Pat. No. 6,522,265 B1, issued to Hillman on Feb. 18, 2003 is way to track a vehicle using the GPS and functions from the vehicle ACS.

An invention as described in U.S. Pat. No. 7,042,347 B2, issued to Cherouny on May 9, 2006 pertains to controlling a vehicle speed remotely via radio link.

Inventions such as U.S. Pat. No. 7,295,925 B2, issued to Breed on Nov. 13, 2007 describes a method and system for preventing accidents between two vehicles, and letting the vehicle's ACS to take control.

In U.S. Pub. No. 2008/0147271 A1, issued to Breed on Jun. 19, 2008 the invention attempts to affect the vehicle dynamics using plurality of sensors.

In U.S. Pub. No. 2008/0154629 A1, issued to Breed on Jun. 26, 2008 a method for setting speed limit for vehicle includes monitoring conditions of the road to calculate a recommended moving speed. The invention takes input from various sensors and GPS to calculate an ideal speed limit for the given situation. Depending on the calculation, the system can sound the alarm or take control of the vehicle dynamics to avoid incidents.

There are inventions such as described in U.S. Pat. No. 3,381,771 issued to Granger on May 7, 1968 does not change the function of the speed controller system, but rather improves the manufacturing efficiency of making components to for the speed controller.

Vehicle speed control system such as described in U.S. Pat. No. 3,088,538, issued to Brennan on May 7, 1963 is an invention of a modified cruise control function with a warning system.

### SUMMARY (OBJECTS AND ADVANTAGES)

It is an object of the present invention to limit the vehicle's maximum speed limit to the roads posted speed limit. The present invention will aid the driver from not violating local, state, & federal mandated speed limit. The invention can have plural modes to accommodate the driver's need such as but not limited to:
(1) On mode to set the maximum speed limit to the road's posted speed limit.
(2) Off mode to allow the vehicle to operate as if the invention did not exist in the vehicle.
(3) Custom mode to let the driver set the maximum speed limit.

### DESCRIPTION OF DRAWINGS

FIG. 1 Is a block diagram of one embodiment of the system of the present invention. The system requires inputs from the driver and current road's posted speed limit. The system will output the calculated information to the vehicle speed control module and other vehicle functions that can affect the acceleration and deceleration.

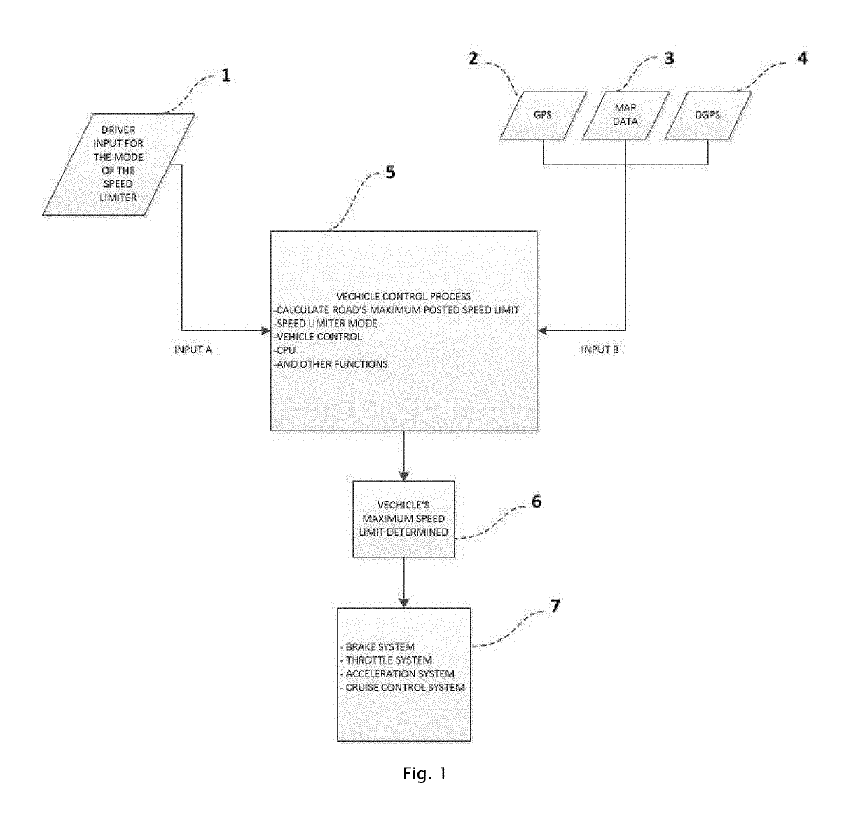

### LIST OF REFERENCE NUMERALS

1 An input from the driver via switch, knob, button, touch pad, or voice to set the mode of operation for the speed limiter.
2 GPS receiver receives signal containing positioning and speed information which is transmitted from a GPS satellite system. The presently implemented Global Positioning System with its constellations of satellites is used to determine moving vehicle speed.
3 Road speed database that is able to provide speed limit of the road being traveled on to the vehicle control processor.
4 Road's maximum speed limit source from DGPS. Differential operation of GPS is used to improve the accuracy and integrity of GPS. Differential GPS places one or more high quality GPS receivers at known surveyed locations to monitor the received GPS signals. This reference station(s) estimates the slowly varying components of the satellite range measurements, and forms a correction for each GPS satellite in view. The correction is broadcast to all DGPS users within the coverage area of the broadcast facilities.
5 The vehicle computer CPU provides data to and controls a plurality of automotive control systems within the vehicle based upon the speed data and the driver entered data.
6 Calculated maximum allowable vehicle speed limit.
7 Represent various automotive subsystems whose operational behavior can be modified by the input from the CPU. These subsystems could represent, for example, but not limited to the vehicle's braking system, the speed control system, acceleration system, deceleration system, throttle system, air and fuel delivery system, accelerator pedal sensors, and cruise control.

### DESCRIPTION OF INVENTION

Preferred embodiment of the system allows the driver to use the invention as one of two ways.

On mode to set the maximum speed limit to the road's posted speed limit.

Off mode to allow the vehicle to operate as if the invention did not exist in the vehicle.

### OPERATION OF INVENTION

The said invention will be integrated into the vehicle system that affects the vehicle acceleration and deceleration. The driver will activate the system by using a knob, button, touch pad, switch, or voice. Once the system is active the driver is not able to go above the road's posted speed limit, or speed limit manually set by the driver. Once the driver determines the speed limiter is no longer needed, the driver can turn it off. Once the system is off, the vehicle will function and perform as if the said invention did not exist in the vehicle.

### DESCRIPTION AND OPERATION OF ALTERNATIVE EMBODIMENTS

There are various possibilities to change the configuration of the invention to allow the invention to look and perform differently:

The said invention can be controlled from the driver via button, knob, switch, touchscreen, and voice.

The said invention can be made to support the one and only function that always set the vehicle maximum speed limit to the posted speed limit.

The said invention can be made to support plural settings such as: on, off, custom speed limit, last used speed limit, snow mode, rain mode, off road, slippery condition, wind condition, etc.

### CONCLUSIONS, RAMIFICATIONS, AND SCOPE OF INVENTION

Thus the reader will see the speed setter limiter is a useful feature in a modern day motor vehicle that can improve safety on the roads and help minimize speed limit violation. It also provides peace of mind to a driver that the vehicle will stay on or below the posted speed limit when the invention is activated, whether the driver is aware or not aware of the road's posted speed limit.

For all elements can it be:

(1) Eliminated or duplicated

(2) Changed in size

(3) Made of different material

(4) Shape variance

(5) Color variance

(6) Connected or associated with its adjacent element in a different manner

(7) Used for different mode of function ex. Enhance safety or warning notification

(8) Made integrally or separately.

Having thus described my invention, I claim:

1. Automotive Control System for controlling vehicle's maximum allowable speed limit. Comprising:
A driver activated switch means such as, but not limited to, a button, switch, knob, or voice for initiating operation of said maximum speed limiter when said switch means is turned on.
Setting means for setting the maximum speed limit of the vehicle. And control means for preventing vehicle velocity past the point of the maximum limit.
Means for detecting a posted speed limit for a road being traveled on such as, but not limited to, a GPS system or speed limit data base for the road being traveled on.
A processor coupled to means of detecting a posted speed limit and a setting means coupled to said processor and arranged to provide information about a roadway posted speed limit on which the vehicle is traveling from a map database to said processor.
Said processor being arranged to process the data on vehicle motion provided by said switch means for activating the speed limit system and the roadway speed information provided by said means for detecting a posted speed limit to control the vehicle's maximum speed limit to prevent a driver from going past the posted speed limit of the road being traveled on.
Idea and concept of incorporating the road's posted speed limit information from GPS, or other road speed database, to limit the vehicle's maximum achievable speed limit from the accelerator pedal or acceleration affecting device.

2. A method of calculating maximum vehicle speed limit.

3. A method for activating various modes of the speed limiter.
